(19) United States
(12) Patent Application Publication
(10) Pub. No.: US 2025/0299701 A1
(43) Pub. Date: Sep. 25, 2025

(54) SHORT CLIP GENERATION FROM SPARSE FRAMES

(71) Applicant: Meta Platforms Technologies, LLC, Menlo Park, CA (US)

(72) Inventors: Chuong Nguyen, San Jose, CA (US); Honghong Peng, Los Altos, CA (US); Xiaoxing Li, Los Gatos, CA (US); Scott Anthony Mehrens, Mountain View, CA (US); Yang Gao, Los Gatos, CA (US); Xilin Li, San Jose, CA (US)

(21) Appl. No.: 19/083,937

(22) Filed: Mar. 19, 2025

Related U.S. Application Data
(60) Provisional application No. 63/567,856, filed on Mar. 20, 2024.

(51) Int. Cl. G11B 27/036; G06V 10/70; G06V 20/40

(52) U.S. Cl. CPC G11B 27/036; G06V 10/70; G06V 20/46

(57) ABSTRACT

This disclosure is related to automatic generation of short clips based on a user input at a device including a camera. A method can include capturing image frames of a scene with the camera, selecting key frames from among the image frames by detecting targets in the scene and motion, applying, with processing logic that is remote from the device that includes the camera, a visual effect to the key frames, and recording an audio recording of the scene in a same time frame that the image frames are captured with the camera. The audio recording is recorded with a microphone of the device, and the method also includes generating an audio clip that matches the visual effect applied to the key frames and generating the short clip by combining the key frames having the visual effect applied and the audio clip.

### CROSS-REFERENCE TO RELATED APPLICATIONS

This application claims priority to U.S. Provisional Application No. 63/567,856 filed Mar. 20, 2024, which is hereby incorporated by reference herein in its entirety.

### TECHNICAL FIELD

This disclosure relates generally to head-mounted devices, and in particular but not exclusively, relates to media generation, such as short clips including video and/or audio, from sparse frames captured with head-mounted devices.

### BACKGROUND INFORMATION

A smart device is an electronic device that typically communicates with other devices or networks. In some situations the smart device may be configured to operate interactively with a user. A smart device may be designed to support a variety of form factors, such as a head-mounted device, a head-mounted display (HMD), or a smart display, just to name a few.

Smart devices may include one or more electronic components for use in a variety of applications, such as gaming, aviation, engineering, medicine, entertainment, video/audio chat, activity tracking, and so on. In some examples, a smart device, such as a head-mounted device or HMD, may include a display that can present data, information, images, media, or other virtual graphics while simultaneously allowing the user to view the real world.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a head-mounted device including a camera configured to capture image frames of a scene, in accordance with aspects of the disclosure.

FIG. 2 illustrates an example process of generating one or more visual effects from key frames of image frames captured by head-mounted device, in accordance with aspects of the disclosure.

FIG. 3 illustrates an example process of using a same set of key frames (e.g. 3 key frames) to generate different short clips with different visual effects, in accordance with aspects of the disclosure.

FIG. 4A illustrates in-between frames in a touring short clip generated from key frames, in accordance with aspects of the disclosure.

FIG. 4B illustrates in-between frames in an action short clip generated from key frames, in accordance with aspects of the disclosure.

FIG. 4C illustrates in-between frames in a long exposure short clip generated from key frames, in accordance with aspects of the disclosure.

FIG. 5 illustrates a flow chart of an example method of short clip generation with audio, in accordance with aspects of the disclosure.

FIG. 6 illustrates a flow chart of an example method of short clip generation with in-between frames, in accordance with aspects of this disclosure.

FIG. 7 illustrates a system including a head-mounted device having processing logic and a device including processing logic, in accordance with aspects of the disclosure.

FIG. 8 illustrates a system including head-mounted device having a processing logic, a remote network including processing logic (e.g. cloud computing), and a device including processing logic, in accordance with aspects of the disclosure.

FIG. 9 illustrates a system including a head-mounted device having a processing logic, a remote network including processing logic and a device including processing logic and illustrates an implementation where logic may generate a proxy short clip for a user device to view and select, in accordance with aspects of the disclosure.

FIG. 10 illustrates an example computing device for the dynamic control of one or more illuminators, in accordance with aspects of the present disclosure.

### DETAILED DESCRIPTION

Embodiments of short clip generation are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise.

Video capture on augmented reality (AR), virtual reality (VR) (or other head-mounted devices such as smartglasses) can be challenging—especially with wide-angle fixed-focus lens cameras. Furthermore, functions such as streaming and storing videos consume battery and processing resources on a head-mounted device. As a further complication, a user wearing a head-mounted device is not necessarily provided with a preview of the images to be captured. In contrast, on a smart device such as a tablet or a smartphone, the display of the smart device commonly provides a preview of the image(s) to be captured by the camera.

Capturing spontaneous moments in photography is challenging, as these moments often happen in the blink of an eye. The user initiating the capturing of a still image frequently misses a “golden window” (e.g., a specific window of time surrounding an event or scene) of opportunity in capturing a specific moment with a camera. On the other hand, streaming and capturing videos consume significant battery and memory (e.g., by requiring capture, storage, and transmission of all video frames), and some or most parts of a captured video may not be interesting to the user. Such videos may not be sharing-friendly (e.g., may be too large, too lengthy, and or otherwise too cumbersome for relatively fast sharing with other users) and may also require manual post-editing (e.g., use of a secondary or tertiary device to manually remove uninteresting portions of a video and/or otherwise shorten the video).

In implementations of the disclosure, short clip generation is described. Short clips may be relatively short video media content, and may also include audio clips. Short clips may be between about 0.5 seconds and five seconds in length, and thus fall between traditional photos and full-motion videos. These short clips may enhance the user experience by presenting an interesting moment in a compact and engaging format. Furthermore, short clips may improve user engagement by providing an easily shareable media content item (i.e., a short clip) that is relatively compact (e.g., in storage size and transmission size) and automatically generated. Additionally, short clips may require less bandwidth to transmit, less memory to store, and less user interactions (e.g., manual selections and other manual processes) by a user requesting a short clip. In these and other manners, short clips provide technical benefits and improvements to traditional media content generation systems, and solve a unique computer-centric problem of providing increased usage time (i.e., by conserving battery power) of head-mounted devices while outputting high-quality short clips (i.e., short video clips of high quality and in an engaging manner).

In an implementation, a user initiates a video capture (e.g., at 30 fps or at another capture rate) on a camera of a head-mounted device using some input to the head-mounted device (e.g. button input, swipe input, audio input, gesture input, etc.). Key frames from the image frames in the video capture are selected by detecting targets in the scene and/or motion in the scene. Processing logic that is remote from the head-mounted device generates the short clip by applying a visual effect to the key frames and by creating additional in-between frames. The remote processing logic may be on a smartphone, tablet, companion computing device, or cloud server, for example.

In an example, the visual effect is one of a touring visual effect, a bounce visual effect, a slow motion visual effect, a panning visual effect, a trailing visual effect, a long exposure visual effect, or a cinemagraph visual effect. An audio recording of the scene (e.g., captured with the initial video capture) may be used to generate an audio clip that matches the visual effect applied to the key frames. Generating the short clip may include adding the audio clip that matches the visual effect of the short clip to the key frames and additional in-between frames.

In an implementation, the key frames of the video capture are selected by a scene analyzer module included in the device (e.g. head-mounted device) that also includes the camera. In these and other implementations, the scene analyzer module may be a software component configured to select key frames and to output the key frames to processing logic remote from the head-mounted device.

In an implementation, the key frames of the video capture are selected by a scene analyzer module included in processing logic that resides off of (remote from) the head-mounted device. In these and other implementations, the scene analyzer module may be a software component executing in a cloud-computing environment, on a virtual server, on a server, or on another computing device remote from the head-mounted device.

In an implementation, the key frames of the video capture are selected by a first scene analyzer module that is included in the device (e.g., the head-mounted device) or by a second scene analyzer module included in processing logic remote from the head-mounted device. In these and other implementations, the first scene analyzer module is operative to select the key frames if battery power and/or available resources of the head-mounted device are above a first threshold of power or availability. In these and other implementations, the second scene analyzer is operative to select the key frames if battery power and/or available resources of the head-mounted device is below the first threshold of power or availability. In this manner, dynamic switching or selection of processing locale is based upon available battery life of the head-mounted device. Other thresholds including network bandwidth usage thresholds, other available network devices, other available companion devices, and other situations may be taken into consideration when selecting between the first and second scene analyzer modules.

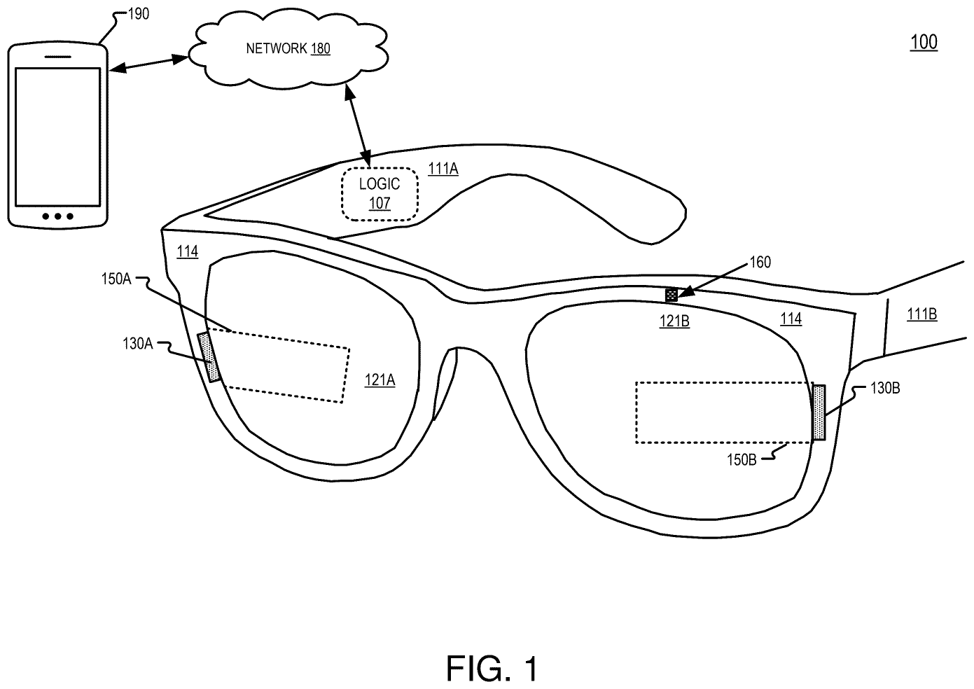

These and other implementations are described in more detail in connection with FIGS. 1-10.

FIG. 1 illustrates a head-mounted device 100 that may include a camera 160 configured to capture image frames of a scene, in accordance with aspects of the present disclosure. Head-mounted device 100 may be smart glasses or a head-mounted display (HMD) configured to present virtual images to the eye of a user. HMD 100 includes frame 114 coupled to arms 111A and 111B. Lens assemblies 121A and 121B are mounted to frame 114. Lens assemblies 121A and 121B may include a prescription lens matched to a particular user of HMD 100. The illustrated HMD 100 is configured to be worn on or about a head of a wearer of HMD 100.

In the HMD 100 illustrated in FIG. 1, each lens assembly 121A/121B includes a waveguide 150A/150B to direct image light generated by displays 130A/130B to an eyebox area for viewing by a user of HMD 100. Displays 130A/130B may include a beam-scanning display or a liquid crystal on silicon (LCOS) display for directing image light to a wearer of HMD 100 to present virtual images, for example.

Lens assemblies 121A and 121B may appear transparent to a user to facilitate augmented reality or mixed reality to enable a user to view scene light from the environment around them while also receiving image light directed to their eye(s) by, for example, waveguides 150. Lens assemblies 121A and 121B may include two or more optical layers for different functionalities such as display, eye-tracking, and optical power. In some embodiments, image light from display 130A or 130B is only directed into one eye of the wearer of HMD 100. In an embodiment, both displays 130A and 130B are used to direct image light into waveguides 150A and 150B, respectively.

The implementations of the disclosure may also be used in head-mounted devices (e.g. smartglasses) that don't necessarily include a display but are configured to be worn on or about a head of a wearer. In these and other implementations, automatic generation of short clips may be provided without a user being able to actively view and/or edit a short clip being generated (i.e., in contrast to image or video capture on devices having a display).

Frame 114 and arms 111 may include supporting hardware of HMD 100 such as processing logic 107, a wired and/or wireless data interface for sending and receiving data, graphic processors, and one or more memories for storing data and computer-executable instructions. Processing logic 107 may include circuitry, logic, instructions stored in a machine-readable storage medium, ASIC circuitry, FPGA circuitry, and/or one or more processors. In one embodiment, HMD 100 may be configured to receive wired power. In one embodiment, HMD 100 is configured to be powered by one or more batteries. In one embodiment, HMD 100 may be configured to transmit and receive wired data including video data via a wired communication channel. In one embodiment, HMD 100 is configured to transmit and receive wireless data including video data via a wireless communication channel. Processing logic 107 may be communicatively coupled to a network 180 to provide data to network 180 and/or access data within network 180 (e.g., by an additional or companion computing device 190). The communication channel between processing logic 107 and network 180 may be wired or wireless.

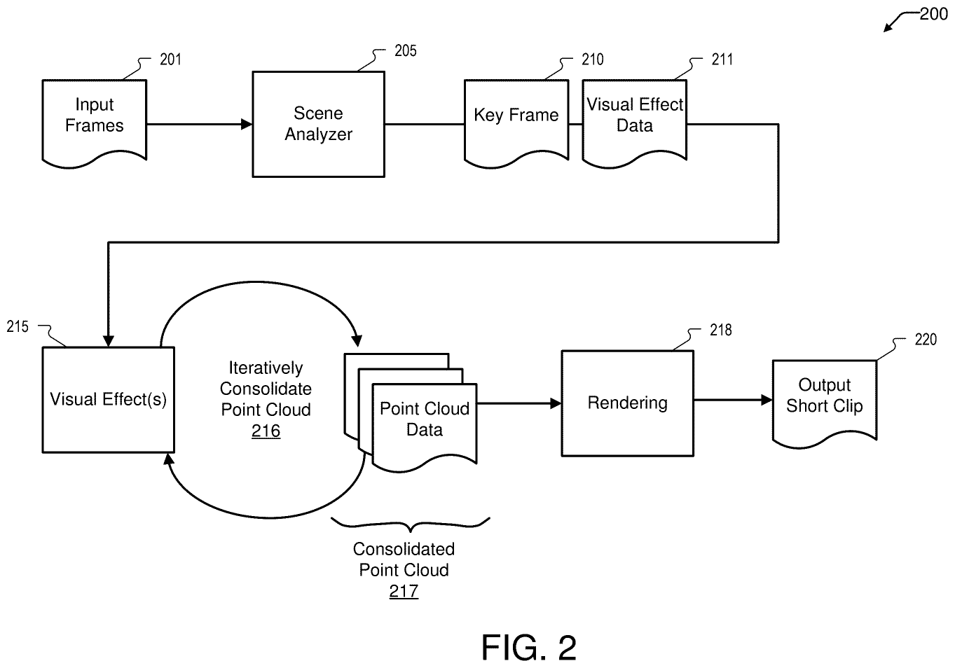

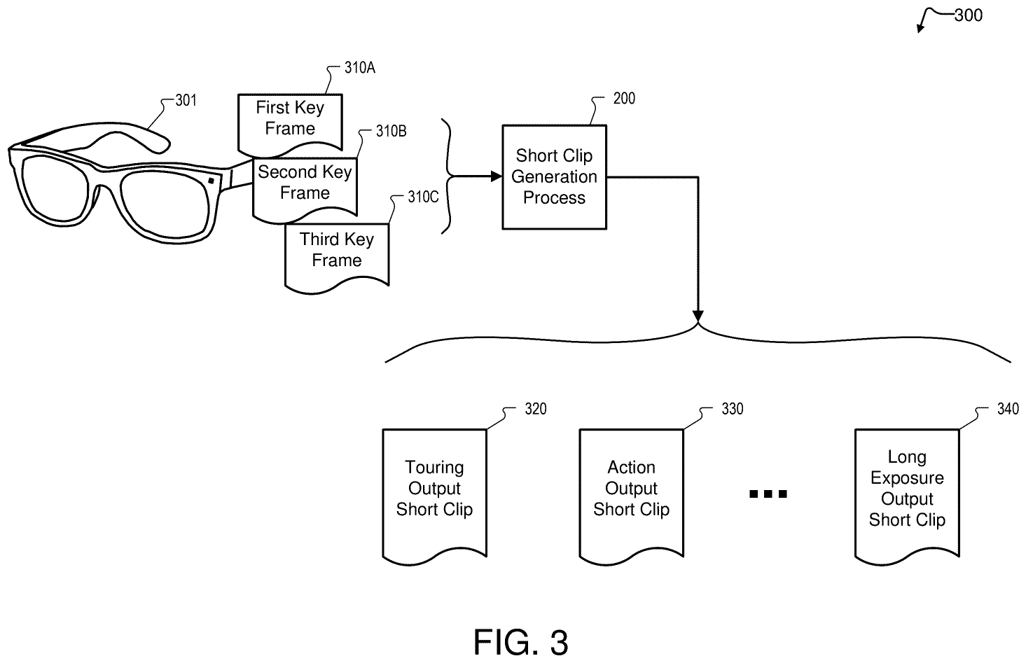

HMD 100 may be configured to capture one or more image frames of a scene within the view of the camera 160. Hereinafter, automatic generation of short clips is described in more detail with reference to FIGS. 2-3.

FIG. 2 illustrates an example process 200 of generating one or more visual effects from key frames of image frames captured by head-mounted device, in accordance with aspects of the disclosure. As illustrated, the process 200 includes receiving input frames 201 from a camera (e.g., a camera on an HMD or other device). The input frames 201 may include images or still frames from a video captured of a scene. A scene analyzer 205 may receive and process the input frames 201.

The scene analyzer module 205 may be a software module configured to give suggestions on possible visual effects (e.g., as visual effect data 211) for a certain capture (e.g., input frames 201). The scene analyzer 205 can receive a short video (e.g. 2 seconds) as input as well as gyro information generated during capture that capture of the short video. The scene analyzer 205 may analyze camera motion (based on gyro information) and local motion (based on the input stream/video) and suggest the most meaningful visual effects as visual effect data 211. For example, for a scene with camera motion and no object motion, “panning” and “trailing” may be the most interesting visual effects to apply. The scene analyzer may also suggest the “most interesting frame” (e.g., key frame 210) to represent the two-second video. This key frame 210 could be used to represent the short clip in user interfaces and effects such as “touring” or the small segment to be used for “Slow Motion”. The scene analyzer may take short video as input and run in the cloud or on a mobile device.

Upon creation of the key frame 210 and visual effect data 211, a visual effects module 215 may be operative to iteratively consolidate a point cloud (i.e., operation 216) such that visual effect or visual effects based on the visual effect data 211 are added to the input frames 201 and/or key frame 210.

The visual effects module 215 may be a software module configured to apply visual effects to frames, to generate additional frames (e.g., in-between frames), and/or to generate consolidated point cloud data 217 based on the applied effects and frames.

The consolidated point cloud 217 may be input by a rendering module 218 configured to render an output short clip 220. For example, the output short clip 220 may be a short video clip (with or without audio) of between about 0.5 to five seconds in length, that includes in-between frames generated from key frames as well as visual effects applied thereto. It is noted that according to some implementations, several different short clips may be generated from the same or similar key frames input to process 200.

FIG. 3 illustrates an example process of using a same set of key frames (e.g. 3 key frames) to generate different short clips with different visual effects, in accordance with aspects of the disclosure. In FIG. 3, key frames 310A, 310B, and 310C may be provided from a device 301, and are used to generate touring short clip video 320, action short clip video 330, and long exposure short clip video 340. In some implementations, deferred processing, discussed in more detail below, will generate multiple short clips (having different visual effects) for the user to choose from. Generating the short clips may include generating in-between frames that are inserted between the key frames. The short clip may include the in-between frames and the key frames, and optionally audio. Generating the in-between frames may include interpolation of the key frames.

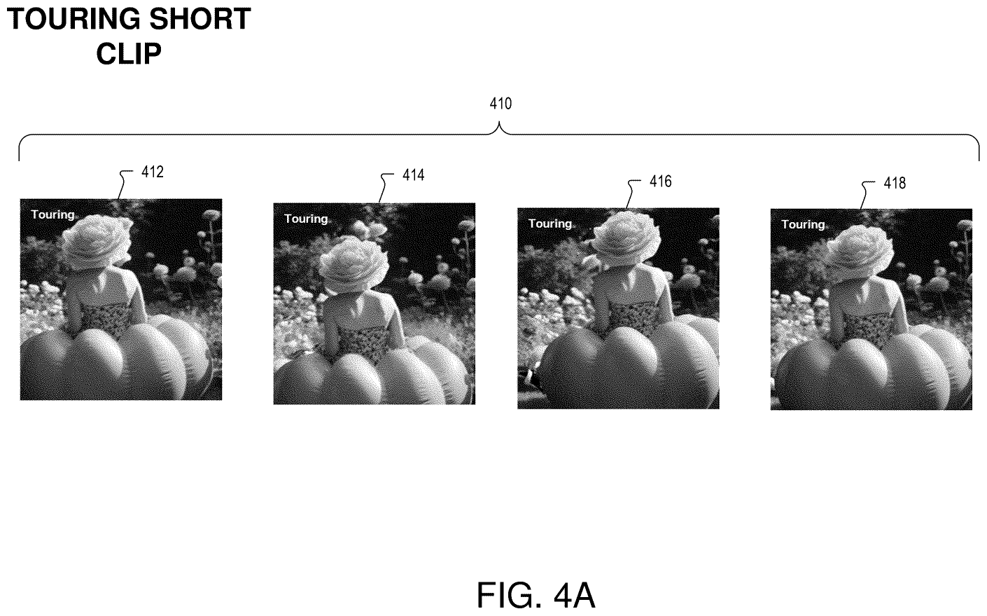

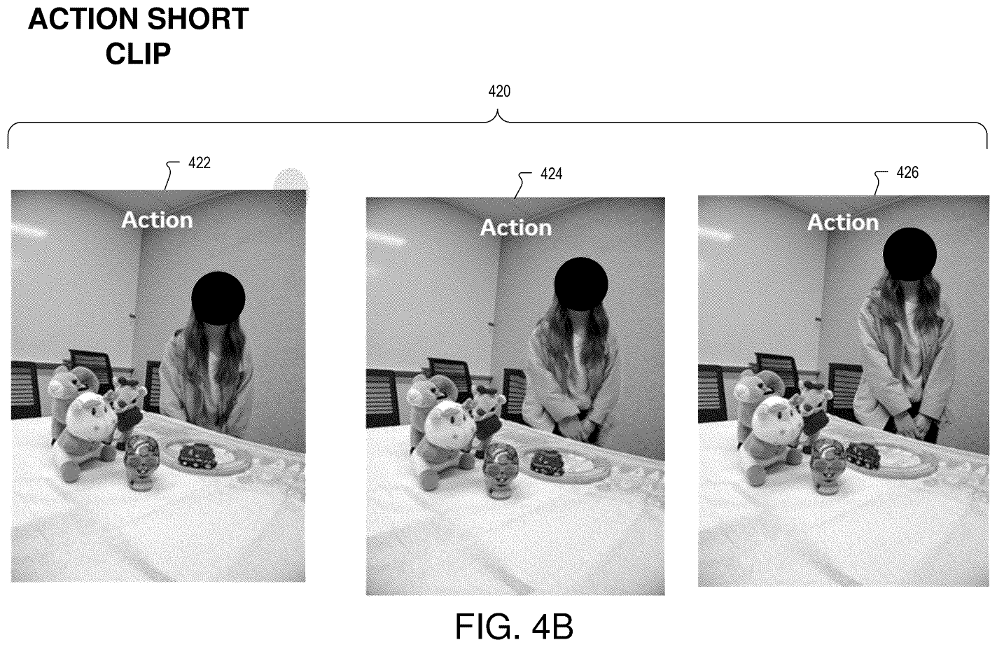

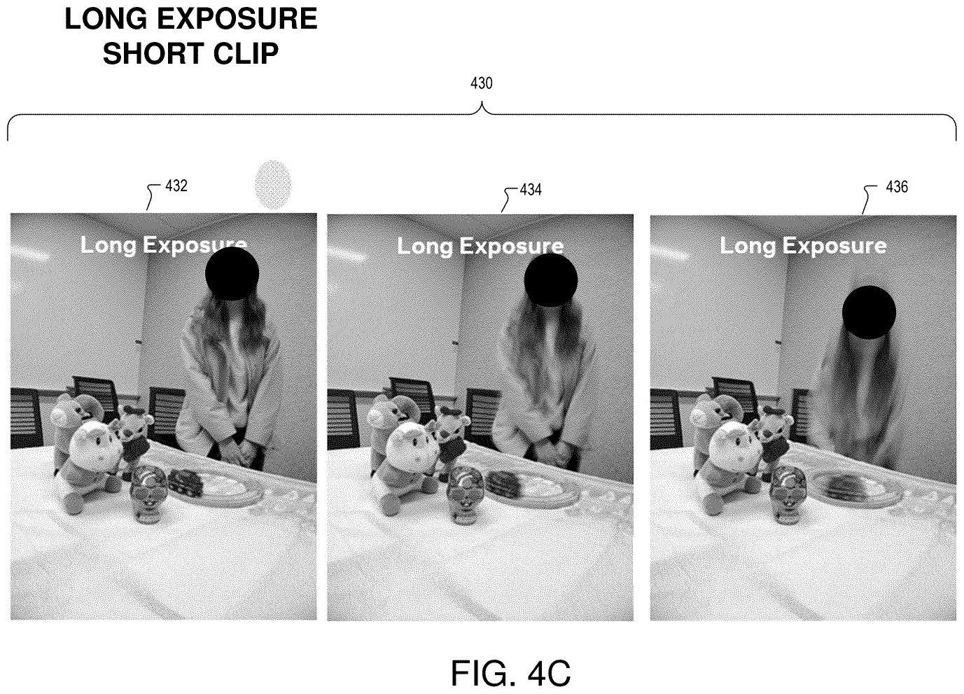

Hereinafter, additional details related to application of visual effects to different key frames and/or interpolated in-between frames are described more fully with reference to FIGS. 4A-4C.

FIG. 4A illustrates in-between frames in a touring short clip 410 generated from key frames 310, in accordance with aspects of the disclosure. The touring short clip 410 can include camera motion and in/out painting as applied visual effects, in some implementations. For a static scene, the short clip touring videos may be viewed in 3D, giving the touring videos a sense of dimensionality and movement when a viewing device such as a smartphone (that is playing the touring video) is tilted. Frames 412, 414, 416, and 418 from touring short clip video 410 illustrate the movement of and about the subject in the short clip touring video 410.

FIG. 4B illustrates in-between frames in an action short clip generated from key frames, in accordance with aspects of the disclosure. For example, frames 422, 424, and 426 in action short clip 420 generated from key frames 310. The action short clip 420 may show the subject sitting or standing. The action short clip 420 may show the subject sitting then standing or standing then sitting. Notably, the object on the table also moves in frames 422, 424, and 426. Action short clip video 420 may also be considered a “bounce” short clip. For “action” or “bounce” short clips, the motion may be bounced in an endless circle or infinite loop.

FIG. 4C illustrates in-between frames in a long exposure short clip generated from key frames, in accordance with aspects of the disclosure. For example, frames 432, 434, and 436 in long exposure short clip 430 are generated from key frames 310. The long exposure short clip 430 may show the subject sitting or standing. The long exposure short clip 430 may show the subject sitting then standing or standing then sitting. Notably, the object on the table is blurred in at least some of frames 432, 434, and 436. It is noted that captured videos may be stabilized before visual effects such as “Long Exposure” are applied. For example, homography warping estimation between different frames may be utilized for video stabilization in some implementations.

Other visual effects that may be applied to key frames 310 include a slow motion visual effect, a panning visual effect, a trailing visual effect, or a cinemagraph visual effect.

Slow motion visual effects may be used for scenes with fast motion, breaking physical limit of device capture (along with SNR improvement) by increasing frame rate from about 30 fps to about 120 fps.

Panning visual effects may be used for scenes with no (or little) object motion and fast camera motion. The foreground is kept sharp while background moves according to the camera motion.

Trailing visual effects may be used for scenes with an object in motion and the object is trailed over time. For example, a bike rider rides pass the camera and the bike and rider “trails” the bike and rider in subsequent frames of the trailing short clip.

Long exposure visual effects may be used for a natural scene motion such as a stream or waterfall, fountain, or clouds moving. Portions of the scene (e.g. waterfall) appear blurry while the static portion of the scene remains sharp in the long exposure short clip.

Cinemagraph visual effects may be used for scenes with minor and repeated movement. A specific element (e.g. water ripple) in a scene may be isolated and a subtle looping motion may be added to the specific element. The result is a combination of a static image with an element that comes to life to create an intriguing blend of photo and video in the cinemagraph short clip.

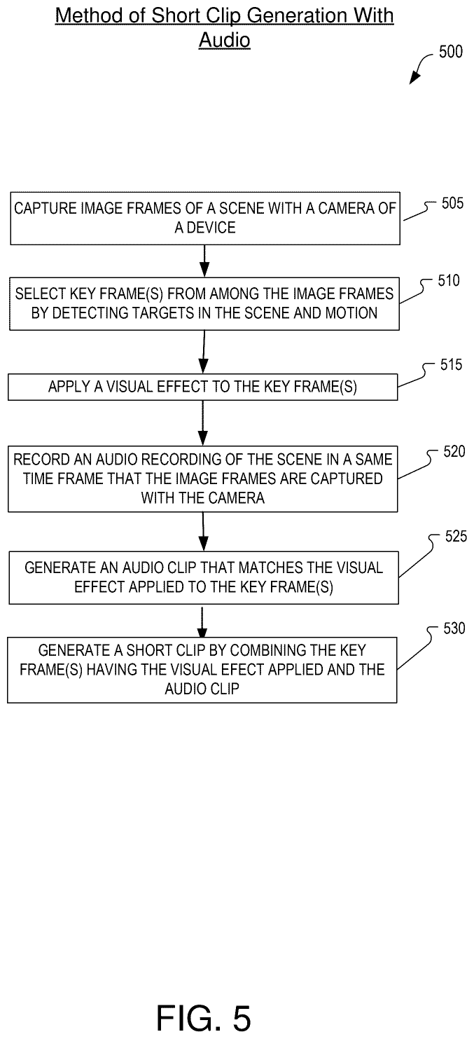

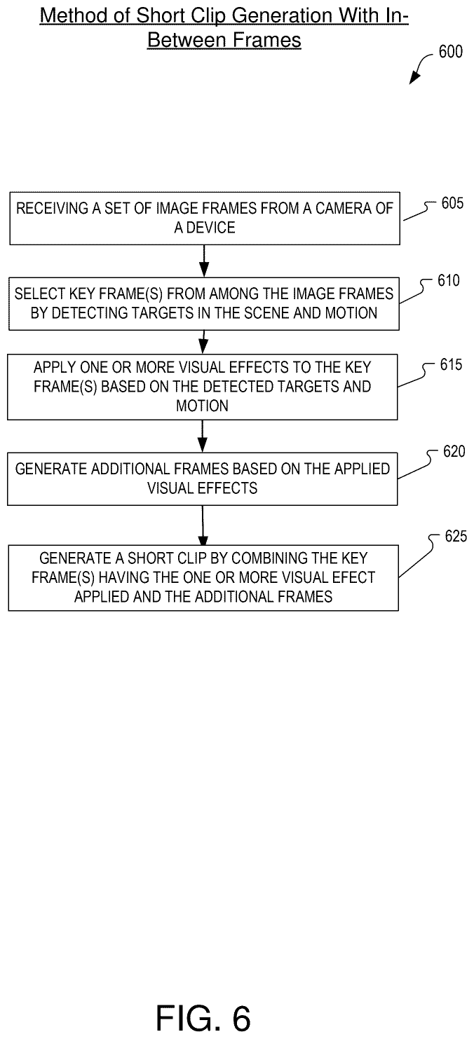

Other visual effects not specifically enumerated here may also be applicable, depending upon any particular implementation. Furthermore, a combination of visual effects may be used to create short clips of differing forms with the same or similar key frames, depending upon analysis by the scene analyzer module of the scene represented in the key frames. Hereinafter, a more detailed discussion of methods of short clip generation, including audio and/or in-between frames, is provided with reference to FIGS. 5 and 6.

FIG. 5 illustrates a flow chart of an example method 500 of short clip generation with audio, in accordance with aspects of the disclosure. The order in which some or all of the process blocks appear in method 500 should not be deemed limiting. Rather, one of ordinary skill in the art having the benefit of the present disclosure will understand that some of the process blocks may be executed in a variety of orders not illustrated, or even in parallel.

In process block 505, image frames of a scene are captured with a camera of a device. For example, a head-mounted device such as HMD 100 may be used to capture the image frames. The capturing of the image frames may be triggered by a user input (e.g., button-press, gesture, key switch, or other input). The image frames of the scene may be captured in a time frame between 0.5 seconds and five seconds.

In some implementations, the camera is included in a head-mounted device, and the image frames are captured without rendering a preview of the image frames to a user of the head-mounted device prior to capturing the image frames. In this manner, devices may provide short clips without further input or distraction to a user of a head-mounted device. Block 505 is followed by block 510.

In process block 510, key frames are selected from among the image frames by detecting targets in the scene and motion. The detecting targets and motion may be performed by a scene analyzer module, in some implementations. For example, the scene analyzer module may be in operative communication with the device, or may be remote from the device. In some implementations, device battery life is a consideration when performing block 510 (e.g., performing on-device or remotely).

In some implementations, selecting key frames from among the image frames includes utilizing Artificial Intelligence (AI) Image saliency. For example, AI Image Saliency may automatically suggest the most salient objects in the captured image for different visual effects, such as “Panning” or “Trailing.” For the proposed effects, light-weight saliency masks may be utilized to identify the salient objects. In addition, AI Video Saliency may also be used in selecting key frames and/or applying visual effects. For example, temporally consistent saliency masks may be utilized in identifying salient objects in motion in a video and/or supporting visual effects such as “Dynamic Panning”.

In some implementations, the device selects the key frames from among the image frames. In these and other implementations, the method can also include transmitting the selected key frames to processing logic that is remote from the device (described more fully with reference to block 515). It is further noted that the selected key frames may be further processed and/or re-selected off-device by the processing logic or other logic.

In some implementations, the key frames are also selected from the image frames by detecting motion within the scene, by detecting camera motion with respect to the scene, and/or by detecting optical blur within the image frames. Block 510 is followed by block 515.

In process block 515, a visual effect is applied to the key frames. For example, the visual effect may be applied with processing logic that is remote and/or external to the device.

In some implementations, the visual effect is one of a touring visual effect, a bounce visual effect, a slow motion visual effect, a panning visual effect, a trailing visual effect, a long exposure visual effect, or a cinemagraph visual effect. In some implementations, the visual effect is two or more visual effects selected from a touring visual effect, a bounce visual effect, a slow motion visual effect, a panning visual effect, a trailing visual effect, a long exposure visual effect, and a cinemagraph visual effect.

In some implementations, the visual effect is selected based on the targets detected and based on motion present in the key frames.

In some implementations, the processing logic may further be operative to generate in-between frames based on the applied visual effects. For example, interpolation may be used to generate the in-between frames. The in-between frames may also include the same or similar visual effects that are applied to the key frames.

In some implementations, in-between frames of a video may be interpolated (e.g., generate 240 frames from the 60 frames for 4× slow motion). In some implementations, artificial intelligence interpolation (AI interpolation) may by used to generate in-between frames. For example, AI interpolation may take two frames and use convolutional neural networks to predict the in-between frames. This technology may be used for “Slow Motion” visual effects as well as increasing a playback time of a short clip, among other uses.

In some implementations, the processing logic is included in a smartdevice. In these and other implementations, a display of the smartdevice renders the short clip generated by the processing logic of the smartdevice. Additionally, a user of the smart device may initiate a publishing of the short clip via the smartdevice, for example, to a network of users or an online platform.

In some implementations, the processing logic is located on a remote cloud server. In these and other implementations, the device may be in operative communication with the remote cloud server over a network. In some implementations, the network is a wired network or a wireless network. Furthermore, in these and other implementations, the device may be in operative communication with the remote cloud server via a communication channel.

In some implementations, the processing logic that is remote from the device also selects the key frames from among the image frames. Block 515 may be followed by block 520.

In process block 520, an audio recording of the scene is recorded in a same time frame that the image frames are captured with the camera. For example, the audio recording can be recorded with a microphone of the device. It is noted that in some implementations, block 520 may be omitted. Block 520 is followed by block 525.

In process block 525, an audio clip is generated that matches the visual effect applied to the key frames. For example, the processing logic that is remote from the device may generate the audio clip. Audio effects (e.g., for the audio clip) for pairing with the short clips may include (1) volume fade in and fade out; (2) phase vocoder such as time stretching (faster or slower) or pitch shifting (higher or lower); and/or (3) Compression/Silence.

Certain audio effects may be matched with certain visual effects. By way of example, time stretching (slower) audio effect may be paired with slow motion visual effect to generate a short clip. It is noted that in some implementations, block 525 may be omitted. Block 525 is followed by block 530.

In process block 530, a short clip is generated by combining the key frames having the visual effect applied and the audio clip. For example, the processing logic that is remote from the device may generate the final short clip for output, sharing, or other use by the requesting user.

While FIG. 5 shows blocks 505-530, in different implementations, one or more of the blocks may be omitted, performed in parallel, or combined with other blocks. For example, in some implementations, blocks 520-525 may be omitted such that no audio is included in the final short clip. Furthermore, blocks 505-530 can be performed (or repeated) in a different order than described above and/or one or more steps can be omitted. Other variations may also be applicable.

As described above, a method of short clip generation with audio can include capturing image frames of a scene with the camera, selecting key frames from among the image frames by detecting targets in the scene and motion, applying, with processing logic that is remote from the device that includes the camera, a visual effect to the key frames, and recording an audio recording of the scene in a same time frame that the image frames are captured with the camera. The audio recording is recorded with a microphone of the device, and the method also includes generating an audio clip that matches the visual effect applied to the key frames and generating the short clip by combining the key frames having the visual effect applied and the audio clip.

As an example use-case of the method 500, when a user triggers a short clip capture, a short video is captured and/or streamed. A scene analyzer detects object(s) and camera motion to select the key frames. The scene analyzer may run either on-device or off-device (remote from the device that captures the video). The key frames may be saved to a cloud-server or a mobile device to apply the visual effect(s) to generate one or more short clips, with or without audio.

These and other aspects of the disclosure provide technical benefits that overcome drawbacks associated with costly video processing on head-mounted devices, as well as devices that can capture but possibly not display video or images to a user during or after capture. While described as including audio specifically, it should be understood that some implementations may exclude audio.

FIG. 6 illustrates a flow chart of an example method 600 of short clip generation with in-between frames, in accordance with aspects of this disclosure. The order in which some or all of the process blocks appear in method 600 should not be deemed limiting. Rather, one of ordinary skill in the art having the benefit of the present disclosure will understand that some of the process blocks may be executed in a variety of orders not illustrated, or even in parallel.

In process block 605, image frames of a scene are captured with a camera of a device. For example, a head-mounted device such as HMD 100 may be used to capture the image frames. The capturing of the image frames may be triggered by a user input (e.g., button-press, gesture, key switch, or other input). The image frames of the scene may be captured in a time frame between 0.5 seconds and five seconds. In some implementations, the camera is included in a head-mounted device, and the image frames are captured without rendering a preview of the image frames to a user of the head-mounted device prior to capturing the image frames. Block 605 is followed by block 610.

In process block 610, key frames are selected from among the image frames by detecting targets in the scene and motion. The detecting targets and motion may be performed by a scene analyzer module, in some implementations. For example, the scene analyzer module may be in operative communication with the device, or may be remote from the device. In some implementations, device battery life is a consideration when performing block 610 (e.g., performing on-device or remotely). Block 605 is followed by block 615.

In process block 615, one or more visual effects are applied to the key frames. For example, the one or more visual effects may be applied with processing logic that is remote and/or external to the device. In some implementations, the visual effects include one or more of a touring visual effect, a bounce visual effect, a slow motion visual effect, a panning visual effect, a trailing visual effect, a long exposure visual effect, or a cinemagraph visual effect. Block 615 is followed by block 620.

In process block 620, additional frames (e.g., in-between frames) are generated based on the applied visual effects. For example, interpolation may be used to generate the in-between frames. The in-between frames may also include the same or similar visual effects that are applied to the key frames. AI interpolation may be used to generate the in-between frames, in some implementations. Block 620 is followed by block 625.

In process block 625, a short clip is generated by combining the kay frames having the one or more visual effects applied and the additional frames. In some implementations, audio may be added by combining an audio clip with the generated short clip.

While FIG. 6 shows blocks 605-625, in different implementations, one or more of the blocks may be omitted, performed in parallel, or combined with other blocks. Furthermore, blocks 605-625 can be performed (or repeated) in a different order than described above and/or one or more steps can be omitted. Other variations may also be applicable.

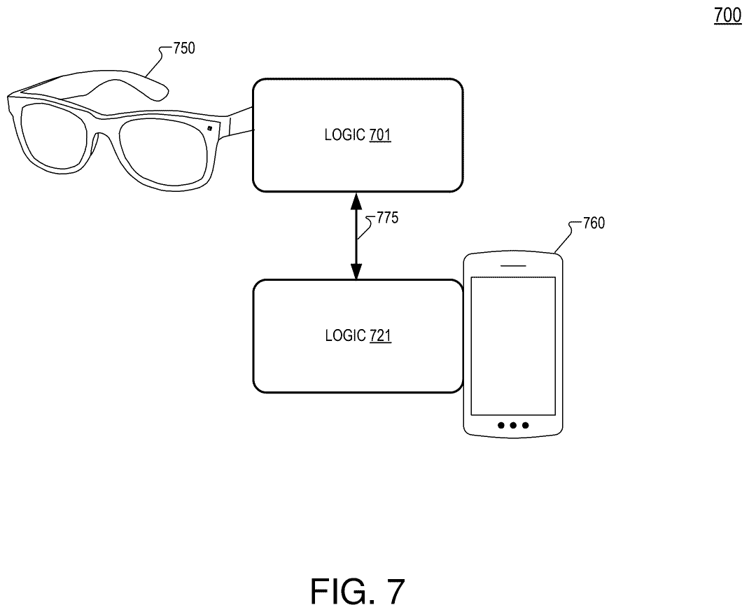

Hereinafter, various systems configured to automatically generate short clips based on user input at a user device are discussed with reference to FIGS. 7-9.

FIG. 7 illustrates a system 700 including a head-mounted device 750 having processing logic 701 and a device including processing logic 721, in accordance with aspects of the disclosure.

A camera of head-mounted device 750 may capture a video. Key frames from among image frames in the video may be selected by detecting targets in the scene captured in the video. A scene analyzer module may be included in logic 701 and/or logic 721 to select the key frames. The video or the key frames may be transmitted (through communication channel 775) from logic 701 to logic 721 of a device (e.g. a smartphone or a tablet) that is remote from head-mounted device 750. Processing logic 721 generates one or more short clips by applying one or more visual effects to the key frames selected by the scene analyzer. Having processing logic 721 (remote from device 750) generate the short clip(s) by applying the one or more visual effects of the processing executed by a device remote from device 750 may save significant processing and power resources of device 750. A user may view, select, and/or publish the short clips to a network using device 760.

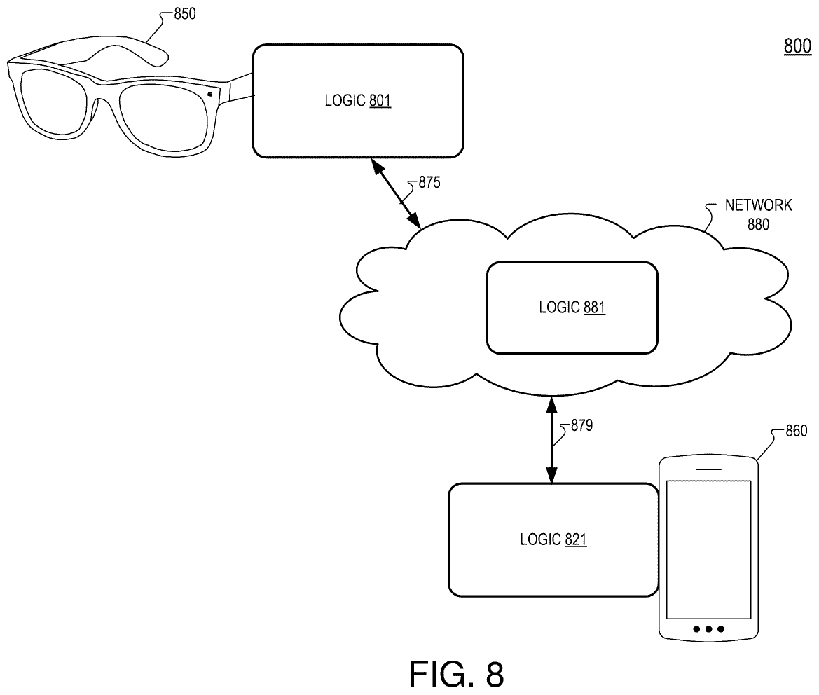

FIG. 8 illustrates a system 800 including head-mounted device 850 having a processing logic 801, a remote network 880 including processing logic 881 (e.g. cloud computing), and a device 860 including processing logic 821, in accordance with aspects of the disclosure. Logic 801 is coupled to logic 881 via communication channel 875 and logic 881 is coupled to logic 821 via communication channel 879. In some implementations, remote processing logic 881 may include a scene analyzer module to select the key frames and/or generate the short clips by applying one or more visual effects to the key frames. Device 860 may then receive the short clips from logic 881 of network 880. Having processing logic 881 (remote from device 850 and 860) generate the short clip(s) by applying the one or more visual effects of the processing executed by a device remote from device 850 may save significant processing and power resources of devices 850 and 860. A user may view, select, and/or publish the short clips to a network using device 860.

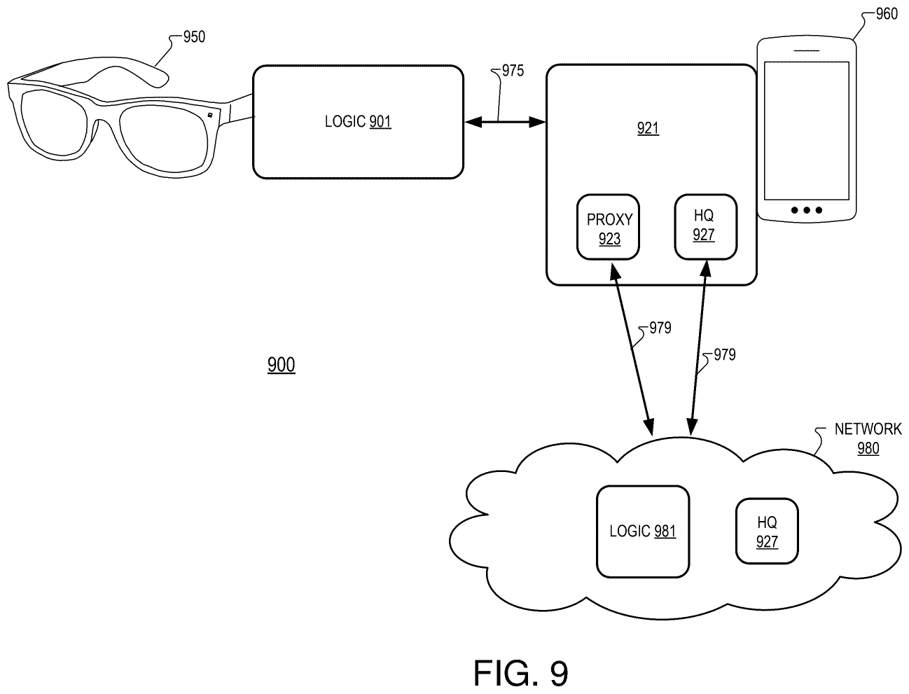

FIG. 9 illustrates a system 900 including a head-mounted device 950 having a processing logic 901, a remote network 980 including processing logic 981 and a device 960 including processing logic 921, and illustrates an implementation where logic may generate a proxy short clip 923 for a user device to view and select, in accordance with aspects of the disclosure. Logic 901 is coupled to logic 921 via communication channel 975 and logic 921 is coupled to logic 981 via communication channel 979.

As noted above, FIG. 9 illustrates an implementation where logic 921 may generate a proxy short clip 923 for a user of device 960 to view and select. In other words, proxy short clip 923 may be available for preview by a user in a mobile device. The user may even decide to publish the proxy short clip 923 to a network using device 960, although a higher quality short clip will be generated that will be the actual short clip that is published to the network. In an implementation, when a user wants to share the short clip to a network, a high quality short clip (e.g. high quality short clip 927) is generated by a server of the network prior to publishing the high quality short clip to the network.

In an example, logic 981 of network 980 performs deferred high-quality processing to generate high quality short clip 927 after receiving (via communication channel 979) proxy short clip 923 or after receiving key frames from a video captured by device 950. High quality short clip 927 may then be transmitted to processing logic 921 to replace proxy short clip 923 in a memory of device 960. High quality short clip 927 may also replace proxy short clip 923 in a database (e.g. cloud storage) associated with a user of device 960. High quality short clip 927 may be published to a network from device 960 or the network may receive high quality short clip 927 from network 980.

As described above with reference to FIGS. 7-9, a system for automatically generating short clips responsive to a user request are provided. Such a system may include a head-mounted device including a camera configured to capture image frames of a scene, and a microphone for recording an audio recording of the scene in a same time frame that the image frames are captured by the camera. The system may also include a remote device that is remote from the head-mounted device and processing logic. The processing logic may be configured to perform a method such as method 500 or 600.

For example, the processing logic, in one implementation, may be configured to select key frames from among the image frames by detecting targets in the scene, generate a short clip by applying a visual effect to the key frames, and generate an audio clip that matches the visual effect applied to the key frames. Generating the short clip includes adding the audio clip that matches the visual effect to the short clip. Other variations and features may also be applicable, and may be combined with the described systems.

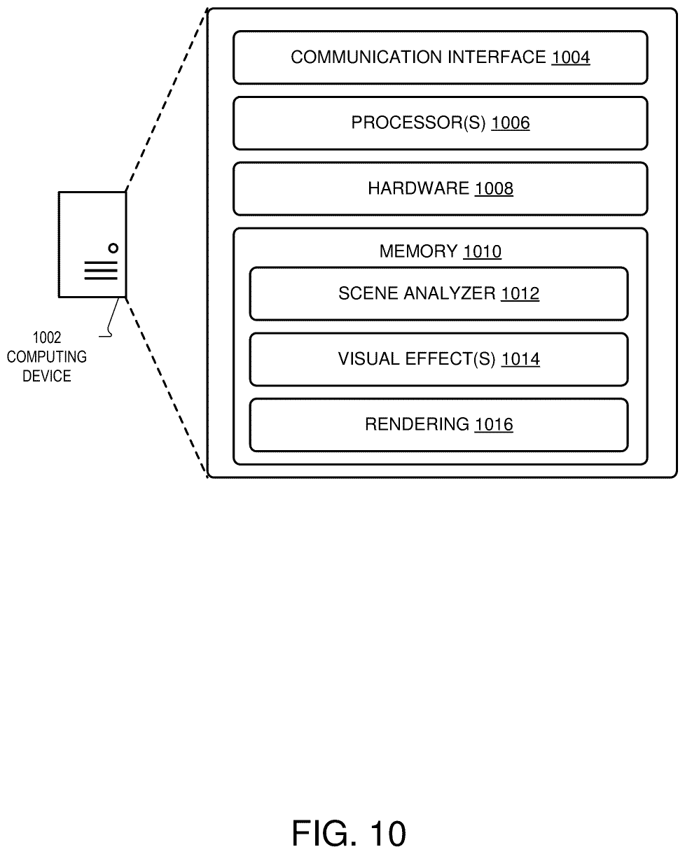

Hereinafter, computing devices that may be used to implement at least a portion of the described aspects are described with reference to FIG. 10.

FIG. 10 illustrates an example computing device 1002 for the automatic generation of one or more short clips, in accordance with aspects of the present disclosure. The illustrated example of computing device 1002 is shown as including a communication interface 1004, one or more processors 1006, hardware 1008, and a memory 1010. In one example, one or more of the components illustrated in FIG. 10 may be incorporated into the frame 114 and/or temple arms 111A/111B of the head-mounted device 100 of FIG. 1. In other examples, one of more of the components illustrated in FIG. 10 may be incorporated into a remote computing device that is communicatively coupled to the head-mounted device 100 for performing one or more aspects of the generation of short clips.

The communication interface 1004 may include wireless and/or wired communication components that enable the computing device 1002 to transmit data to and receive data from other networked devices. The hardware 1008 may include additional hardware interface, data communication, or data storage hardware. For example, the hardware interfaces may include a data output device (e.g., electronic display, audio speakers), and one or more data input devices.

The memory 1010 may be implemented using computer-readable media, such as computer storage media. In some aspects, computer-readable media may include volatile and/or non-volatile, removable and/or non-removable media implemented in any method or technology for storage of information such as computer-readable instructions, data structures, program modules, or other data. Computer-readable media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

The processors 1006 and the memory 1010 of the computing device 1002 may implement a scene analyzer module 1012, a visual effect(s) module 1014, and a rendering module 1016. The scene analyzer module 1012, visual effect(s) module 1014, and rendering module 1016 may include routines, program instructions, objects, and/or data structures that perform particular tasks or implement particular abstract data types (e.g., perform one or more of the methods 500, 600 and/or portions thereof). The memory 1010 may also include a data store (not shown) that is used by the scene analyzer module 1012, visual effect(s) module 1014, and/or rendering module 1016.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g. 701, 721, 801, 821, 881, 901, 921, 981) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” (e.g. 1010) described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks (e.g., 180, 880, 980) may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels 775, 875, 879, 975, and 979 may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method comprising:
capturing image frames of a scene with a camera of a device;
selecting key frames from among the image frames by detecting targets in the scene and motion;
applying, with processing logic that is remote from the device that includes the camera, a visual effect to the key frames;
recording an audio recording of the scene in a same time frame that the image frames are captured with the camera, wherein the audio recording is recorded with a microphone of the device;
generating, with the processing logic that is remote from the device, an audio clip that matches the visual effect applied to the key frames; and
generating, with the processing logic that is remote from the device, a short clip by combining the key frames having the visual effect applied and the audio clip.

2. The method of claim 1 further comprising:
generating, with the processing logic that is remote from the device, in-between frames based on the applied visual effects, wherein generating the short clip further includes combining the key frames having the visual effect applied with the in-between frames.

3. The method of claim 1, wherein the visual effect is one of a touring visual effect, a bounce visual effect, a slow motion visual effect, a panning visual effect, a trailing visual effect, a long exposure visual effect, or a cinemagraph visual effect.

4. The method of claim 1, wherein the visual effect is selected based on the targets detected and based on motion present in the key frames.

5. The method of claim 1, wherein the processing logic is included in a smartdevice, and wherein a display of the smartdevice renders the short clip generated by the processing logic of the smartdevice, wherein a user of the smartdevice may initiate a publishing of the short clip via the smartdevice, and wherein the publishing of the short clip is to a network of users.

6. The method of claim 1, wherein the processing logic is located on a remote cloud server.

7. The method of claim 1, wherein the processing logic that is remote from the device also selects the key frames from among the image frames.

8. The method of claim 1, wherein the device that includes the camera selects the key frames from among the image frames, the method of claim 1 further comprising:
transmitting the selected key frames to the processing logic that is remote from the device.

9. The method of claim 1, wherein the key frames are also selected from the image frames by detecting motion within the scene.

10. The method of claim 1, wherein the key frames are also selected from the image frames by detecting camera motion with respect to the scene.

11. The method of claim 1, wherein the key frames are also selected from the image frames by detecting optical blur within the image frames.

12. The method of claim 1, wherein the key frames are selected by a scene analyzer module included in the device that also includes the camera.

13. The method of claim 1, wherein the key frames are selected by a scene analyzer module included in processing logic that resides off the device.

14. The method of claim 1, wherein the camera is included in a head-mounted device, and wherein the image frames are captured without rendering a preview of the image frames to a user of the head-mounted device prior to capturing the image frames.

15. The method of claim 1, wherein the image frames of the scene are captured in a time frame between 0.5 seconds and five seconds.

16. The method of claim 1, wherein the generating the short clip includes generating in-between frames that are inserted between the key frames, the short clip including the in-between frames and the key frames, and wherein the in-between frames include a same visual effect as the key frames.

17. The method of claim 16, wherein the generating the short clip includes generating in-between frames that are inserted between the key frames, the short clip including the in-between frames and the key frames, and wherein generating the in-between frames includes interpolation of the key frames.

18. The method of claim 1, wherein the generation of the short clip is initiated in response to a user input on the device.

19. The method of claim 1, wherein the selecting key frames from among the image frames includes utilizing Artificial Intelligence (AI) Image saliency.

20. A system for generating a short clip, the system comprising:
a head-mounted device including:
a camera configured to capture image frames of a scene; and
a microphone for recording an audio recording of the scene in a same time frame that the image frames are captured by the camera;
a remote device that is remote from the head-mounted device; and
processing logic configured to:
select key frames from among the image frames by detecting targets in the scene;
generate a short clip by applying a visual effect to the key frames; and
generate an audio clip that matches the visual effect applied to the key frames, wherein generating the short clip includes adding the audio clip that matches the visual effect to the short clip.
